(19) United States
(12) Patent Application Publication
(10) Pub. No.: US 2012/0101685 A1
(43) Pub. Date: Apr. 26, 2012

(54) Power Steering System For A Vehicle And Method For Limiting A Torque Applied By A Power Steering System

(76) Inventors: Frank Peter Engels, Solingen (DE); Jens Dornhege, Pulheim (DE)

(21) Appl. No.: 13/277,723

(22) Filed: Oct. 20, 2011

(30) Foreign Application Priority Data
Oct. 21, 2010 (DE) 102010060097.0

(51) Int. Cl. B62D 6/00; B62D 6/08; B62D 6/02

(52) U.S. Cl. 701/41

(57) ABSTRACT

A power steering system (1) for a vehicle comprises a torque limiter (5) for limiting a torque applied by the power steering system (1), wherein the limitation is based on the anticipated reaction by the vehicle.

The invention relates to a power steering system for a vehicle and to a method for limiting a torque applied by a power steering system.

Modern steering systems not only permit customary power assistance to be provided for the driver but also enable steering torques to be applied in order to make possible driver assistance systems which increase the comfort and the safety. Furthermore, steering torques can be applied in order to reduce disruptive torque influences which can be caused by the vehicle or the roadway surface.

Power assistance is defined in this context as application of a torque which amplifies the torque applied by the driver. This application of torque can subsequently be treated in a similar way to the other comfort assistance systems. Furthermore, the described method can, however, also be used for any individual functionality.

The steering wheel is the haptic interface with the driver. While it is a precondition that torques which are applied within the context of the assistance systems do not bring about a hazardous situation, the torque which is applied must be configured in such a way that the vehicle can be controlled by the driver even in the event of a fault (a torque which is applied undesirably). The safety requirements mean that when the means for applying the torque are being configured it has to be taken into account that in the event of a fault the worst possible application of torque does not constitute a danger for the overall system composed of the driver, vehicle and situation.

Known approaches usually limit the amplitude and dynamics of the steering torque which is superimposed on the torque applied by the driver and on the power assistance. Customer clinics and expert clinics are run in order to determine controllable thresholds. Owing to the variance in the evaluations, it is necessary here to start from the worst possible case, i.e. in the event of a fault the limitation must be tailored to the most critical case or the most critical evaluation.

This leads to a situation in which the possible performance of additional functions or means of applying torque cannot always request torques which are appropriate or necessary for the respective situation.

The invention is based on the object of improving the possibilities for reliably applying assistance steering torques in a motor vehicle, i.e. in this sense the present invention limits the effect of an incorrect application of torque which can occur in exceptional cases.

This object is achieved with the respective features of claims 1 and 4. Advantageous developments of the invention are defined in the dependent claims.

According to a first aspect of the invention, a power steering system for a vehicle comprises a torque limiter for limiting a torque which is applied by the power steering system, wherein the limitation is based on the anticipated reaction by the vehicle.

The perception of undesired applications of torque is dependent, in particular, on the situation-specific steering activity. The subjective evaluations of the interventions are not primarily determined by the forces/torques which occur at the steering wheel but rather depend on the degree of lateral-dynamics reactions or yaw rates which result from the changes in steering wheel angle which are associated with the application processes. The output steering torque can therefore be largely ignored when a limitation is being configured.

When assessing the controllability of an undesired application of torque, the driver therefore does not assess the torque itself but rather the resulting vehicle reaction. The extent of the lateral-dynamics reactions and/or yaw rates is estimated, said estimation being directly related to the evaluation of the controllability by the driver and therefore taking into account the variables of the driver, vehicle and/or situation and making possible an application of torque which is dependent on the driver, vehicle and/or situation and which permits the greatest benefit for the respective function without infringing the safety requirements. That is to say that limitation is carried out only when, or only to the extent that, the applied torque gives rise to a correspondingly critical vehicle reaction or to a vehicle reaction which is not desired by the driver. A critical or undesired vehicle reaction can be assessed within the grouping of the driver/vehicle/situation.

Since according to the invention the possible reaction of the vehicle is considered in a comprehensive fashion, the power steering system is, on the one hand, very reliable and on the other hand, the room for maneuver in terms of the application of torques can be maximized.

The power steering system can comprise a sensor for determining the anticipated reaction by the vehicle, wherein the sensor determines a steering system reaction. Due to the inertia of the vehicle, the vehicle reaction occurs only after a delay. An undesired vehicle yaw reaction is caused in this context only by an undesired change in the steering angle. The reaction of the steering system to the incorrect torque request can also be evaluated as an intermediate variable. A rapid reaction by the torque limiter can be ensured by means of this variable which can be detected directly.

The sensor can detect a steering angle acceleration, a steering angle speed and/or a steering angle. These measured values can be detected easily and reliably or can be determined by means of integration or differentiation. One or more measured values can be used.

According to a second aspect, the invention is directed to a method for limiting a torque applied by a power steering system, wherein the limitation is based on the anticipated reaction by the vehicle. The advantages and the modifications described above apply. The calculation and/or assessment of the limitation can be performed in a controller, a torque limiter and/or a power steering system.

The anticipated reaction by the vehicle can be determined by means of a steering system reaction. This value can be determined without delay as an intermediate step.

The steering system reaction can be determined by means of a steering angle acceleration, a steering angle speed and/or a steering angle. These values can be determined easily and then used to define the limitation.

The duration of the steering angle acceleration, steering angle speed and/or steering angle can be taken into account. This additional information can be used in the determination of the limitation in order therefore to optimize the security, reliability and sensation for the driver.

The vehicle speed can be taken into account. This additional input allows the safety to be improved since the speed of a vehicle can have an influence on the controllability of the vehicle. For example, it is therefore possible to use a relatively small anticipated vehicle reaction as a limiting base starting from certain speeds.

The driver's intention can be determined by means of a manual torque applied to the steering wheel. This additional information is used to determine the driver's request and can be used as a further parameter for configuring the limitation. This increases, on the one hand, the safety and helps, on the other hand, to improve the driver's comfort since application processes which are undesired by the driver can be avoided or attenuated. Furthermore, this information can be used to assist the driver's request.

In the case of a manual torque counter to the applied torque, the amplitude of the application process can be limited to an absolute value in order thus to avoid or limit unpleasant experiences for the driver. This measure also ensures that the driver retains full control over the vehicle at any time. The absolute value can be permanently predefined or can be capable of being adapted to the respective situation.

The current driving state of the vehicle can be taken into account in the plausibility checking of the manual torque. For this purpose, values such as the steering angle, the velocity, the lateral acceleration and/or the yaw rate can be used. The situation of the vehicle can be detected very satisfactorily with one or more of these values, and influences acting on the steering angle can be apportioned satisfactorily according to the driver, vehicle and surroundings/situation. This comprehensive situation analysis permits rapid and precise limitation of the torque.

A steering system reaction can be evaluated as plausible if it is caused at least partially by the manual torque. It therefore becomes apparent that the reaction by the steering system is desired by the driver and not caused by external influences or incorrect application of torque. If a steering system reaction is classified as plausible, it is possible, for example, to relax threshold values or limiting values for the safety and/or to enable certain comfort functions.

The steering system reaction and/or the manual torque can be determined from an observer model. Modern steering systems can be represented on a model basis as multi-mass oscillating systems. By means of corresponding observer models it is then possible to differentiate whether a steering angle acceleration is caused by external forces, manual torque of the driver or by the torque of the servomotor.

The grip position of the driver can be determined from changes in the mass inertia at the steering wheel. Said grip position provides additional information about the intention and/or about the perception of the situation by the driver. For example, it is possible to differentiate between relaxed driving and expectation of a difficult situation by the driver. These and further distinctions or evaluations can be taken into account in the limitation of the torque and improve the safety and the comfort.

The coefficient of friction between the vehicle and the roadway can be taken into account. This additional information also improves the estimation of the situation and permits better adaptation of the limitation.

The invention will be described in more detail below with reference to the drawing, in which:

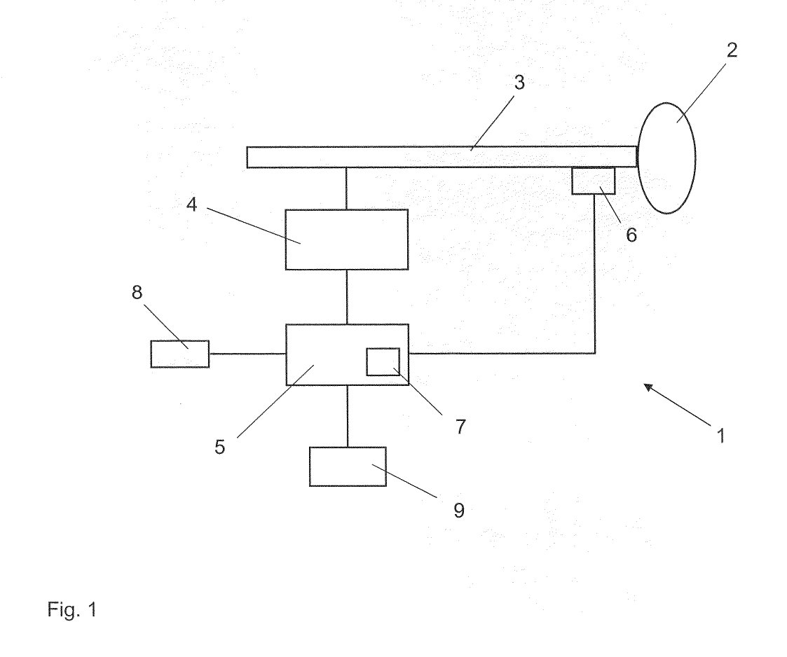

FIG. 1 is a schematic illustration of a power steering system according to the invention.

The drawings serve merely to explain the invention and do not restrict it. The drawings and the individual parts are not necessarily to scale. Identical reference symbols denote identical or similar parts.

FIG. 1 is a schematic illustration of a power steering system 1 of a motor vehicle. Of the motor vehicle, the steering wheel 2 and a steering column 3 connected thereto are illustrated schematically.

The power steering system 1 comprises a servomotor 4 or a similar device for applying torques to the steering column 3, the steering wheel 2 or a further device connected to the steering system of the wheels.

Furthermore, the power steering system 1 comprises a torque limiter 5 which limits the torque which is to be applied. The limitation can take place in terms of amplitude, frequency or both. The limitation extends from complete suppression of the application to slight attenuation, and can be adapted in an infinitely variable fashion to the respective situation. The term limitation is directed to the effect, as it were in the sense of minimizing damage. The term limitation can in an individual case also include amplification of the applied torque if it becomes apparent, for example, that the situation requires it.

The torque which is to be applied is limited as a function of the anticipated reaction by the vehicle. The anticipated reaction by the vehicle is determined indirectly by means of a reaction by the steering system, for example by a wheel steering angle, by the steering wheel 2 or the steering column 3. The steering system reaction is sensed by means of a sensor 6. The sensor 6 can determine a steering angle acceleration, a steering angle speed and/or a steering angle. A plurality of sensors can also be used or one or more of the indicated values can be transferred from a control system which already has these values available. It is also possible to transfer values from a control system or the like, from which values one or more of the above-mentioned values can then be calculated. In the case of steering systems in which the wheel steering angle is not a direct function of the steering wheel angle, the sensor 6 is to detect the wheel-side steering angle, and its speed and/or its acceleration.

In addition to the measured values of the steering angle acceleration, the steering angle speed and/or the steering angle, the duration of the respective process can also be sensed. The sensing of the duration can either be performed directly in the sensor 6 or in the torque limiter 5 which is connected to the sensor 6 and receives its measurement results.

With the specified measured values, the torque limiter 5 can estimate the anticipated reaction by the vehicle and use this as a basis for limiting the torque which is applied by the servomotor 4. The estimation or calculation of the anticipated reaction can also be performed in other control computers, for example the power steering system or a safety system.

The sensor 6 or a further sensor system can determine a steering column torque, which permits conclusions to be drawn about the driver's intention. Furthermore, the grip position of the driver can be determined from changes in the mass inertia at the steering wheel. With these values it is possible to determine the behavior, the estimation of the situation and the intention of the driver, and they can be used to limit the applied torque.

The torque limiter 5 can contain an observer model 7 by means of which the steering system reaction, external forces and/or the manual torque applied to the steering wheel by the driver are/is determined, or evaluated or the plausibility thereof is checked.

A further sensor system can be connected to the torque limiter 5 in order to detect the vehicle and/or the respective situation of the vehicle. A sensor 8 measures the speed of the vehicle and outputs the measured value to the torque limiter 5. A further sensor 9 supplies data about the steering wheel angle, the lateral acceleration and the yaw rate to the torque limiter 5. These measured values can also be obtained from suitable information systems or computer systems.

The torque limiter 5 then evaluates information about the driver, the vehicle and the respective situation in order thereby to limit the applied torque in accordance with the anticipated reaction of the vehicle or the driver's request.

By means of the measured values and/or the observer model or models 7 it is now possible to differentiate whether a steering angle acceleration is caused by external forces, the manual torque applied by the driver or by the torque of the servomotor 4, or which proportions are present. A steering angle acceleration can be assumed to be plausible and desired if it is caused at least partially by the driver's manual torque.

Since the absolute value of the manual torque is zero only in the case of straight-ahead travel, it may be helpful to calculate an offset for the driver's manual torque by means of the general driving state, characterized for example by the steering angle, driving velocity, lateral acceleration and yaw rate, in order to check the plausibility of steering angle acceleration values. This offset should correspond to the driver's manual torque which is typically present in this driving situation without superimposition.

If the driver's manual torque counteracts the steering torque which is to be applied, the amplitude is also to be limited in such a way that in the case of undesired superimposition the driver can safely control the vehicle.

Depending on the classification of the superimposition of steering torque, various limiting values can now be defined for a steering angle acceleration or steering angle speed whose plausibility has not been checked. Since, for example, suppression of interference is intended to ensure that external forces which occur do not bring about any change in the steering angle or the torque applied by the driver, the limiting value can be set low here.

For driver assistance systems which mainly serve to provide the driver with information, low to medium-sized steering angle accelerations can be permitted. However, the absolute steering angle speed must be limited here.

Many functions demand a rapid buildup in the steering angle. However, the absolute angle which can be achieved has to be limited here if the driver does not check the plausibility of the change in angle by his manual torque.

The limiting values mentioned above for steering angle acceleration, steering angle speed, steering angle and driver's opposing torque are directly related to the yaw reaction via vehicle-specific parameters (for example the wheel base). These limiting values can therefore be determined both from theoretical considerations by means of the vehicle parameters and in driving trials.

What is claimed is:

1. A power steering system for a vehicle, having a torque limiter (5) for limiting a torque applied by the power steering system (1), wherein the limitation is based on an anticipated reaction by the vehicle.

2. The power steering system as claimed in claim 1, having a sensor (6) for determining the anticipated reaction by the vehicle, wherein the sensor (6) determines a steering system reaction.

3. The power steering system as claimed in claim 2, wherein the sensor (6) detects a steering angle acceleration, a steering angle speed and/or a steering angle.

4. A method for limiting a torque which is applied by a power steering system (1), the method comprising the steps of:
determining the anticipated reaction by the vehicle; and
limiting the torque which is applied by the power steering system based on the anticipated reaction by the vehicle.

5. The method as claimed in claim 4, wherein the anticipated reaction by the vehicle is determined by means of a steering system reaction.

6. The method as claimed in claim 5, wherein the steering system reaction is determined by means of a steering angle acceleration, a steering angle speed and/or a steering angle.

7. The method as claimed in claim 6, wherein the time period of the steering angle acceleration, the steering angle speed and/or the steering angle is taken into account.

8. The method of claim 4, wherein the vehicle speed is taken into account.

9. The method of claim 4, wherein the driver's intention is the anticipated reaction, and the driver's intention is determined by means of a manual torque applied to the steering wheel (2).

10. The method as claimed in claim 9, wherein in the case of a manual torque which is counter to the applied torque the amplitude of the application is limited to an absolute value.

11. The method as claimed in claim 9, wherein the current driving state of the vehicle is taken into account in a plausibility checking of the manual torque.

12. The method as claimed in claim 11, wherein a steering system reaction is evaluated as plausible if it is caused at least partially by the manual torque.

13. The method of claim 9, wherein the manual torque is determined from an observer model (7).

14. The method, of claim 5 relative to a steering system reaction, wherein the steering system reaction is measured by the grip position of the driver, and the grip position of the driver is determined from changes in the mass inertia at the steering wheel (2).

15. The method of claim 4, wherein the coefficient of friction between the vehicle and the roadway is taken into account.

16. The method of claim 5 wherein the steering system reaction is determined from an observer mode (7).
